(19) United States
(12) Patent Application Publication
(10) Pub. No.: US 2015/0181112 A1
(43) Pub. Date: Jun. 25, 2015

(54) PREPROCESSING APPARATUS FOR RECOGNIZING USER

(71) Applicant: Electronics and Telecommunications Research Institute, Daejeon-si (KR)

(72) Inventors: Cheon-In OH, Daejeon-si (KR); Han-Kyu LEE, Daejeon-si (KR); Young-Ho JEONG, Daejeon-si (KR); Jin-Woo HONG, Daejeon-si (KR)

(21) Appl. No.: 14/274,814

(22) Filed: May 12, 2014

(30) Foreign Application Priority Data
Dec. 24, 2013 (KR) 10-2013-0163039

(51) Int. Cl. H04N 5/232; G06K 9/62; H04N 1/00; H04N 5/357

(52) U.S. Cl. CPC H04N 5/23219; H04N 5/357; G06K 9/6215; H04N 1/00244

(57) ABSTRACT

A preprocessing apparatus of recognizing a user. The preprocessing apparatus may include an image acquisition controller to compare a received filmed image and a pre-registered background image, and update the pre-registered background image based on whether light is changed; a Modified Census Transform (MCT) transformer to transform the pre-registered background image or the updated background image through an MCT method to generate an MCT background image, and transform the received filmed image through the MCT method to generate an MCT filmed image; and a difference image processor to differentiate the MCT filmed image and the MCT background image to generate a difference image.

### CROSS-REFERENCE TO RELATED APPLICATION(S)

This application claims the benefit under 35 U.S.C. §119(a) of Korean Patent Application No. 10-2013-0163039, filed on Dec. 24, 2013, in the Korean Intellectual Property Office, the entire disclosure of which is incorporated herein by reference for all purposes.

### BACKGROUND

1. Field

The following description relates to image processing technology, more specifically, technology of a method for recognizing a facial region.

2. Description of the Related Art

As one of technologies for recognizing a body without user efforts and less inconvenience for the user to take special actions or to approach or come into contact with a predetermined sensor, a face recognition technology has been receiving attention in various application fields. A user recognition technology is applied to a broadcast service field, and is capable of being used to recognize the user's viewing behavior, and effectively analyze advertising effects. The user recognition technology in the broadcast service field is to detect a face from an input image, compare the input image with information of a pre-registered viewer's feature points, and identify the user, and extract personal information, such as a sex, age, etc., and behavior information, such as whether the user is viewing, the number of viewers, emotion and motion, etc. The extracted information is transferred to a service provider or an effectiveness measuring institute. Here, the personal information is extracted, and the original data may be transferred as it is; however, when a server is managing the personal information, a terminal sometimes uses a method of distinguishing the viewers, and extracting only an ID and transferring the ID to the server.

An image processing, such as face recognition, needs a lot of calculations, and an amount of calculation by the terminal may be different depending on types of viewing behavior required by the server that receives the data. In general, in TV environments, calculations of the image processing are processed based on TV itself or a set-top box, but with respect to calculations and costs for performing other functions, there might be limitations in performance allocation or additional chipset mounting for the image processing itself. For those reasons, if the terminal is in charge of all analyses for extracting the viewing behavior information, usage situations of CPU or memory, etc., used for the calculations for each terminal may be different, so extracting the viewing behavior information required by the server may not be performed well.

Thus, to reduce those burdens, provided is a method of using an additional user recognition server that is entirely or partially in charge of the user recognition functions. The terminal performs only roles of collecting an image and transferring the image to the server, and the server is in charge of all the processes of recognizing the viewer and extracting the viewing behavior information. However, in that case, performance problems on the terminal side may be solved, but various problems may occur in the server. First, transferring the image data without additional image processing processes may cause a load in the networks. From the point of view of the server, the server may collect and analyze the image data of all the terminals, which may take a lot of time, and have weakness in terms of costs of initial building and management, etc. Likewise, to solve the problems of a one-sided method for extracting viewing behavior information, a technique of a collaboration form of sharing and separately analyzing status information of each other is being used. However, such collaboration-based technology of recognizing the viewer has some problems that need to be solved. The facial region of the user may be detected by comparing differences between the input image and the pre-registered background image; however, because there may be a difference between the light of the images at the registration time point and at the input time point, a normal facial region may not be detected. Also, it is possible that the background itself may be changed, so a technology for overcoming those problems and detecting a precise facial region is necessary.

### SUMMARY

The following description relates to a preprocessing apparatus and method for recognizing a user, which have strong resistance to a light change and an environment change.

In one general aspect, a preprocessing apparatus of recognizing a user includes an image acquisition controller to compare a received filmed image and a pre-registered background image, determine whether light is changed, and update the pre-registered background image based on whether the light is changed; a Modified Census Transform (MCT) transformer to transform the pre-registered background image or the updated background image through a binary conversion technique based on an average mask value that has a similar value in response to a light change, generate an MCT background image, transform the received filmed image through an MCT method, and generate an MCT filmed image; and a difference image processor to differentiate the MCT filmed image and the MCT background image, and generate a difference image. In addition, the preprocessing apparatus may include an image register to store the pre-registered background image, and register and store the updated background image; a background noise remover to determine, as noise, a part where a size of grouped pixels included in the generated difference image is less than a predetermined standard, and remove the part; and a facial region candidate detector to filter, based on facial skin color, the difference image where the noise is removed, predict a face location, reconfigure a preprocessed image, and generate the reconfigured preprocessed image.

The reconfigured preprocessed image may be configured into at least one of: cutting an outermost region that includes all regions gone through the filtering based on the facial skin color; in response to detection of two or more user faces, collecting only the two or more user faces and configuring the two or more user faces into one image; and comprising the two or more user faces, each of which is considered a single image.

The image acquisition controller may include an image acquirer to receive the filmed image generated by an image filming device; a light change detector to compare the received filmed image and the pre-registered background image, detect the light change based on a preset standard, and in response to the detection of the light change, and request an update of the pre-registered background image; and an object motion detector to, in response to the request of the update of the pre-registered background image, compare two or more frames of the received filmed image, detect a motion of an object, and in response to no detection of the motion of the object, update the pre-registered background image through the filmed image. In response to the detection of the motion of the object, the object motion detector waits for a predetermined amount of time until the motion of the object is not detected.

In another general aspect, a preprocessing method includes detecting whether light is changed through a comparison of a received filmed image and a pre-registered background image; in response to no detection of whether the light is changed, transforming the pre-registered background image through a binary conversion technique based on an average mask value that has a similar value in response to a light change to generate an MCT background image, and transforming the received filmed image through an MCT method to generate an MCT filmed image; and differentiating the MCT filmed image and the MCT background image to generate a difference image. In addition, the preprocessing method may include determining, as not a facial region but noise, a part where a size of grouped pixels included in the generated difference image is less than a predetermined standard, and removing the part; and filtering, based on facial skin color, the difference image where the noise is removed, predicting a face location, and reconfiguring a preprocessed image to be transmitted.

The preprocessing method may include, in response to the detection of the light change, requesting an update of the pre-registered background image; comparing two or more frames of the received filmed image, and detecting a motion of an object; and in response to no detection of the motion of the object, update the pre-registered background image through the received filmed image.

Other features and aspects may be apparent from the following detailed description, the drawings, and the claims.

### BRIEF DESCRIPTION OF THE DRAWINGS

FIG. 1 is a diagram illustrating an example of a system of recognizing a user according to an exemplary embodiment.

FIG. 2 is a diagram illustrating an example of a preprocessing apparatus of recognizing a user according to an exemplary embodiment.

FIG. 3 is a diagram illustrating an example of an image acquisition controller of a preprocessing apparatus of recognizing a user according to an exemplary embodiment.

FIG. 4 is a diagram illustrating an example of a preprocessing method for recognizing a user according to an exemplary embodiment.

FIG. 5 is a diagram illustrating an example of a method for updating a background in a preprocessing method for recognizing a user according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

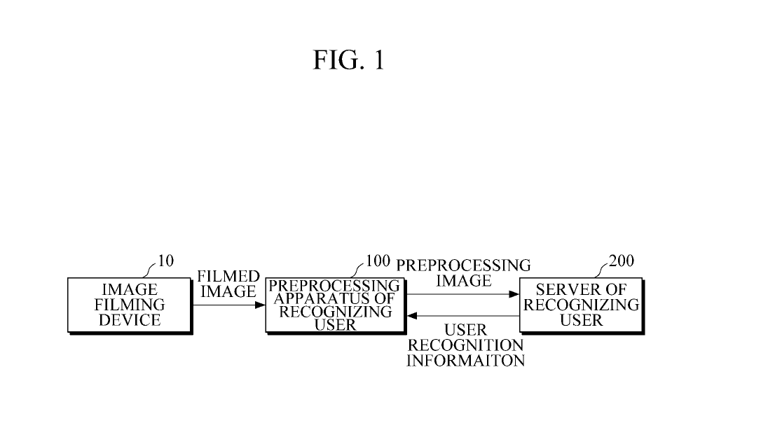

FIG. 1 is a diagram illustrating an example of a system of recognizing a user according to an exemplary embodiment.

Referring to FIG. 1, a system of recognizing a user according to an exemplary embodiment includes a preprocessing apparatus 100 of recognizing a user, and a server 200 of recognizing a user.

The system of recognizing a user according to an exemplary embodiment is user recognition technology that is performed in a collaborative manner between the preprocessing apparatus 100 and the server 200 which share and separately analyze each other's status information. Prior to a process of recognizing a user, the preprocessing apparatus 100 and the server 200 exchange each other's status information. The status information includes information on an available function an available calculation source and an available information type of the preprocessing apparatus 100 and the server 200. The server 200 distinguishes the available function of the preprocessing apparatus 100 through the status information exchange, and sets a type and measurement range of data to be processed by the preprocessing apparatus 100. If the server 200 determines that the available function of the preprocessing apparatus 100 is not sufficient to acquire all kinds of viewing behavior information, the preprocessing apparatus 100 may reduce a measurement range capable of being acquired from the preprocessing apparatus 100, thereby lessening a load of the preprocessing apparatus 100 in processing the data. By those operations, the measurement range of the preprocessing apparatus 100 is adjusted, thereby avoiding a case of overload causing abnormal execution of the preprocessing process.

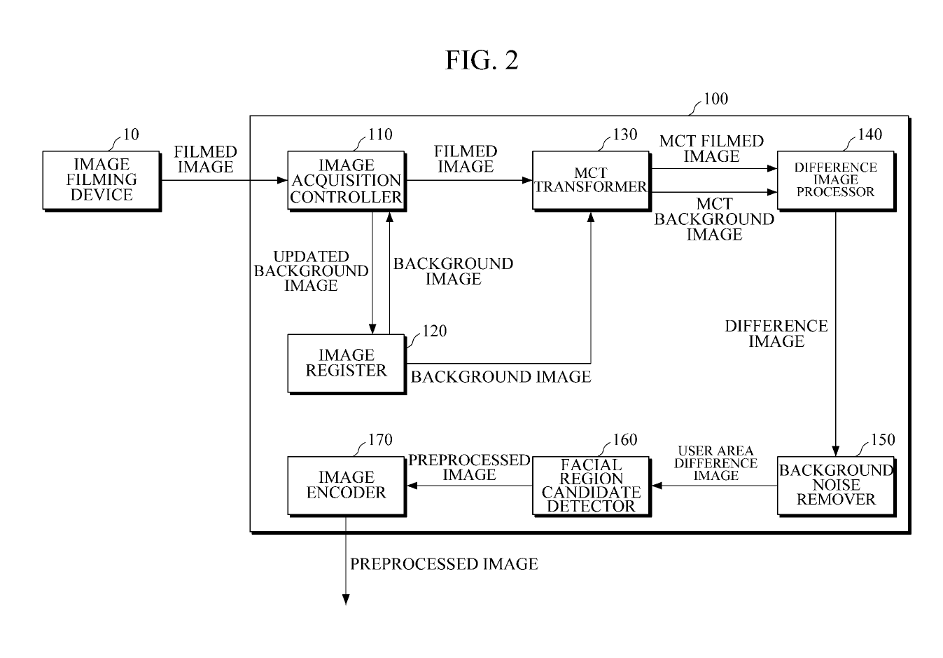

The preprocessing apparatus 100 preprocesses a filmed image collected from an image filming device 10. A preprocessing level of the preprocessing apparatus 100 may be set according to a determination of the server 200 based on the status information. The preprocessing apparatus 100 encodes the preprocessed filmed image into a form proper to the server 200, and transfers the encoded filmed image to the server 200. The preprocessing apparatus 100 does not transfer the collected filmed image as it is, but transfers the preprocessed image generated by processing the filmed image through the preprocessing process so that the preprocessing apparatus 100 may reduce a transmission amount of data transferred to the server 200 with the required image maintained. The preprocessing process of the preprocessing apparatus 100 is described later in FIG. 2.

The server 200 analyzes the preprocessed filmed image received from the preprocessing apparatus 100, detects a facial region of the user, and identifies the user. The server 200 extracts the viewing behavior information from the preprocessed image based on the detected facial region and the identified user. The viewing behavior information extracted by the server 200 may be used in TV terminals, service providers, or advertising effect measuring institution depending on the purpose. Also, the server 200 transfers user recognition information for recognizing the user to the preprocessing apparatus 100, which may use the user recognition information in the process of identifying and recognizing the user.

FIG. 2 is a diagram illustrating an example of a preprocessing apparatus of recognizing a user according to an exemplary embodiment.

Referring to FIGS. 1 and 2, a preprocessing apparatus 100 of recognizing a user includes an image acquisition controller 110, an image register 120, a Modified Census Transform (MCT) transformer 130, a difference image processor 140, a background noise remover 150, a facial region candidate detector 160, and an image encoder 170.

The image acquisition controller 110 receives the filmed image in real time from the image filming device 10 in response to external event occurrence or to its own schedule. Also, the image acquisition controller 110 compares a background image registered in advance in the image register 120 with the filmed image received in real time, and detects a degree of a light change at a filming point in time. If there is a big difference between light of the received filmed image and light of the background image registered in the image register 120, i.e. if there is a big difference in light environments, a distortion may be generated during a process of extracting the difference image. Thus, the image acquisition controller 110 compares the detected degree of the light change and a preset standard, and determines whether the light brightness has been changed. If it is determined that the light brightness has not been changed, the image acquisition controller transfers the received filmed image to the MCT transformer 130.

If it determined that the light brightness has been changed, the image acquisition controller 110 starts a process for updating the background image. The determination that the light brightness has been changed denotes that there is a big difference in the light environments between the received filmed image and the stored registered image. Thus, to avoid generating the distortion during the process of extracting the difference image, the image acquisition controller 110 updates a background image with a present light state. The image acquisition controller 110 stores the newly updated background image in the image register 120, and transfers the received filmed image to the MCT transformer 130.

The image register 120 transfers the background image stored in advance in order to enable the image acquisition controller 110 to determine a light change. If the image acquisition controller 110 determines that there is no light change, the image register 120 transfers the background image to the MCT transformer 130. If the newly updated background image is received from the image acquisition controller 110, the image register 120 transfers the updated background image to the MCT transformer 130. The background image stored in the image register 120 is comparison standard information for the user recognition, and includes a code value for a user's initial image and facial features together with the initial background image.

The MCT transformer 130 receives the filmed image from the image acquisition controller 110, and the background image from the image register 120. The background updating with respect to the environmental change (or a light change) is performed through the process of updating the background image of the image acquisition controller 110, so problems caused from the rapid light change may be solved, but if continuous and consecutive updating is performed, a lot of calculation resources and time may be consumed. Thus, the MCT transformer 130 uses a binary conversion technique based on an average mask value in order to handle minor or not rapid light change. In particular, the MCT transformer 130 may use a Modified Census Transform (MCT) method that is a binary conversion technique based on an average mask value. The basic concept of the MCT method is to divide the image into mask units to be transformed to a value of 1 if each pixel is larger than an average pixel value inside the mask, and transforming the divided image into a value of 0 if the pixel value is less than the average. The MCT method has a feature of presenting using contrast information in a local area, and digitizes and presents a relation between each divided area and surrounding areas, thereby the image transformed through the MCT method may include an MCT value that is digitized for each area.

The MCT transformer 130 transforms the received filmed image to the MCT filmed image through the MCT method, and transforms the received background image to the MCT background image. If the MCT transformer 130 transforms the filmed image and the background image through the MCT method, other parts except for a part where the user is located in the image may have pixel values similar to each other. The MCT filmed image and the MCT background image transformed through the MCT transformer 130 are transferred to the difference image processor 140.

The MCT transformer 130 transforms the filmed image received from the image acquisition controller 110 into the MCT filmed image through the MCT method, and transforms the background image (or an updated background image) received from the image register 120 to the MCT background image through the MCT method. The images with a relatively dark light and a relatively bright light may turn to show definite differences in light environments with the original images prior to the conversion. However, when the two images are transformed through the MCT method and compared against each other, the two images are transformed similar to each other even though there has been a change in the light environments. That is, if the filmed image and the background image are transformed through the MCT method, other parts except for a part where the user is located have pixels similar to each other as the MCT filmed image and the MCT background image. Thus, the filmed image and the background image are transformed by the MCT transformer 130, thereby having strong resistance to light change so that the distortion may be reduced during the process of differentiating the filmed image and the background image and generating the difference image.

The difference image processor 140 differentiates the MCT filmed image and the MCT background image, which are received from the MCT transformer 130, and generates a difference image. The received MCT filmed image and the received background image have similar pixels except for where the user is located, and as such, if the MCT filmed image and the MCT background image transformed through the MCT are differentiated, the difference image including only the information on the user region is generated. The difference image processor 140 transfers the difference image generated after differentiating the MCT filmed image and the MCT background image to the background noise remover 150.

The background noise remover 150 determines a part where a size of the grouped pixels included in the received difference image is less than a predetermined standard as not the facial region but noise, and removes the part. The background noise remover 150 removes a part except for the facial region by removing noise of the received difference image, thereby generating a difference image of the user region. Also, the background noise remover 150 transfers the generated difference image of the user region to the facial region candidate detector 160.

The facial region candidate detector 160 filters the difference image of the user region, where the noise is removed, based on facial skin color, predicts a location of the face, and reconfigures a preprocessed image to be transmitted. The preprocessed image reconfigured by the facial region candidate detector 160 may be configured by cutting the outermost region that includes all the regions gone through the skin color filtering. In addition, if two or more user faces are detected, the preprocessed image reconfigured by the facial region candidate detector 160 may be configured into one image after collecting only the facial regions, or be configured to include two or more user faces by considering each user face as a single image. Also, the preprocessed image reconfigured by the facial region candidate detector 160 may be configured to include information on a beginning position and an end point where all facial candidate regions are included within the image together with an original image or a grayscale image. In that case, there is an effect of reducing an execution range of detecting the face in a server 200 of recognizing a user, but which may be more disadvantageous than other reconfigured preprocessed images in terms of a transmission load. The facial region candidate detector 160 transfers the generated preprocessed image to the image encoder 170.

The image encoder 170 encodes the preprocessed image transferred from the facial region candidate detector 160 into a form proper to the server 200 or communication environments, and transfers the encoded preprocessed image to the server 200.

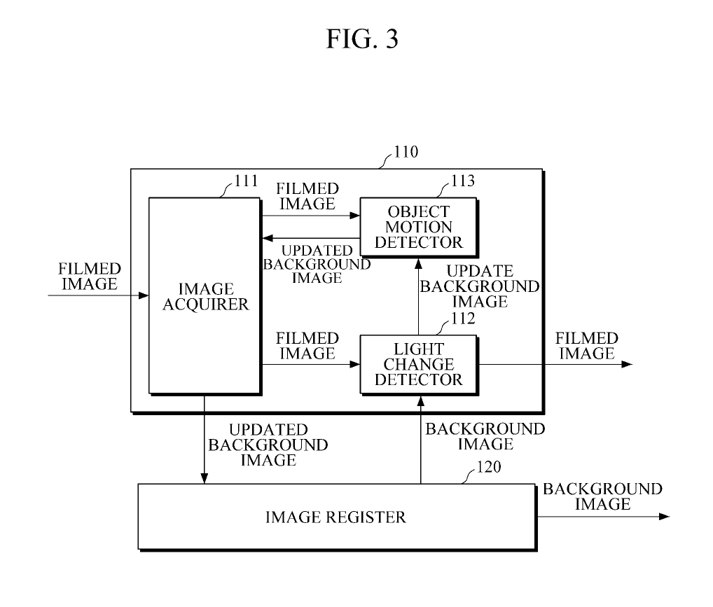

FIG. 3 is a diagram illustrating an example of an image acquisition controller of a preprocessing apparatus for recognizing a user according to an exemplary embodiment.

Referring to FIGS. 2 and 3, in a preprocessing apparatus 100 for recognizing a user according to an exemplary embodiment, an image acquisition controller 110 includes an image acquirer 111, a light change detector 112, and an object motion detector 113.

The image acquirer 111 receives a filmed image in real time from an image filming device 10 in response to external event occurrence or to its own schedule. The image filming device may be configured separately with the preprocessing apparatus 100, or configured to be equipped within the preprocessing apparatus 100. The image acquirer 111 transfers the received filmed image to the light change detector 112 to detect light change.

In addition, if the image acquirer 111 receives a request for updating a background image in response to a determination of the light change detector 112 and the object motion detector 113, the image acquirer 111 transfers, to the image register 120, the filmed image at the point in time when the request for updating the background is received, as the updated background image.

If the filmed image is received from the image acquirer 111, the light change detector 112 compares the filmed image with the background image registered in the image register 120, and detects the change of light environments (a difference of light) between the two images. If there is a big difference in light between the filmed image and the background image, the light change detector 112 determines that the light environments have been changed a lot. If there is a big difference in light between the filmed image and the background image, a possibility for the distortion and error increases during a process of extracting a difference image. Thus, when determining that there is a big difference in the light environments, the light change detector 112 first transmits a request for updating the background image to the object motion detector 113 to newly update the background image. However, if a difference in light between the filmed image and the background image is less than a predetermined standard, the light change detector 112 determines that the light environments have not been changed much, and transfers the filmed image to the MCT transformer 130.

If the request for updating the background image is received from the light change detector 112, the object motion detector 113 receives the filmed image from the image acquirer 111. Also, the object motion detector 113 acquires and compares two or more frames at the point in time when the received filmed image is detected, and detects the object motion. If the object motion is detected, the object motion detector first pauses updating the background image to perform an update of a normal background image. The object motion detector 113 updates the received filmed image to a new background image if the object motion is not detected through acquiring and comparing the two or more frames at the point in time the received filmed image is detected.

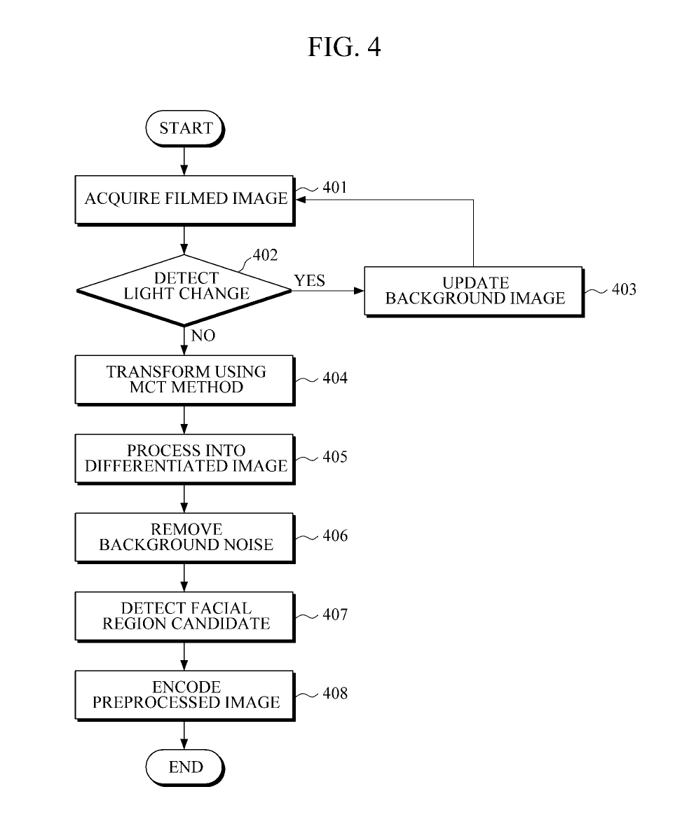

FIG. 4 is a diagram illustrating an example of a preprocessing method for recognizing a user according to an exemplary embodiment.

Referring to FIG. 4, in a method for recognizing a user according to an exemplary embodiment, a filmed image is first acquired in real time from an image filming device in 401. The image filming device may be configured separately with a preprocessing apparatus 100 for recognizing a user, or configured to be equipped within the preprocessing apparatus 100.

When the filmed image is received from the image filming device, a pre-registered background image is compared to the received filmed image, and a change of light environments (a difference of light) between the two images is detected in 402. The background image stored in advance is comparison standard information used in recognizing a user, and may include a code value with respect to an initial image and facial characteristics of a user's face, as well as an initial background image. According to a preset standard of a light difference after comparing the pre-registered background image and the received filmed image, if the comparison result is greater than or equal to the preset standard, it is determined that the light environments have been changed, and if the comparison result is less than or equal to the preset standard, it is determined that the light environments have not been changed. If there is a big difference of the light between the filmed image and the background image, a possibility for a distortion and an error may increase in a process of extracting a difference image. Thus, if it is determined that there has been a big difference in the light environments, the light change detector 112 needs to update the pre-registered background image to a background image that includes present light environments.

If the light change is detected according to the preset standard of the light difference, a procedure of updating the received filmed image to a new background image is performed in 403. To newly update the background image, at the point in time when the received filmed image is detected, the two or more frames are acquired and compared, and the motions of the object are detected, but if the motions of the object are not detected, the received filmed image is updated to a new background image.

If the light change is not detected according to the preset standard of the light difference, the filmed image and the background image are transformed using a Modified Census Transform (MCT) method in 404. The background update is performed with respect to an environment change of the background (or a light change) through an operation 403 of updating the background image, so problems caused from a rapid light change may be solved, but the continuous and consecutive updating may consume a lot of calculation resources and calculation time. Thus, the MCT method is used to handle minor or not rapid light change. The MCT method is a method for digitizing and presenting relations between each divided area and surrounding areas, and the image transformed through the MCT method may include an MCT value that is digitized for each area. The received filmed image is transformed into an MCT filmed image through the MCT method, and the received background image (or an updated background image) is transformed into an MCT background image. If the MCT transformer 130 transforms the filmed image and the background image through the MCT method, other parts except for a part where the user is located in the image may have pixel values similar to each other.

If the MCT filmed image and the MCT background image are generated through the MCT transform, the MCT filmed image and the MCT background image are differentiated, thereby generating the difference image in 405. The received MCT filmed image and the received MCT background image have pixel values similar to each other except for the part where the user is located. As such, by those operations of differentiating the MCT filmed image and the MCT background image, which are transformed through the MCT method, the difference image that includes only information on the viewer region is generated.

If the difference image is generated after differentiating the MCT filmed image and the MCT background image, a part where a size of the grouped pixels included in the generated difference image is less than a predetermined standard is determined as noise and removed in 406. By removing the part except for the facial region by removing the noise of the difference image, a difference image of the user region is generated.

Through the operation 406, if the difference image of the user region including only the user region is generated, the difference image of the user region where the noise has been removed is filtered based on a facial skin color, thereby reconfiguring the preprocessed image to be transmitted after predicting where the face location is in 407. The reconfigured preprocessed image may be configured after cutting the outermost region that includes all the regions filtered based on the facial skin color. In addition, if two or more user faces are detected, the preprocessed image reconfigured by a facial region candidate detector 160 may be configured into one image after collecting only the face regions, or may be configured to include two or more user faces after handling each user face as a single image. Also, the preprocessed image reconfigured by the facial region candidate detector 160 may be configured to include information on a beginning position and an end point where all facial candidate regions are included within the image together with an original image or a grayscale image. In that case, there is an effect of reducing an execution range of detecting the face in a server 200 of recognizing a user, but which may be more disadvantageous than other reconfigured preprocessed images in terms of a transmission load. When the preprocessed image is reconfigured, the preprocessed image is encoded into a form proper to communication environments or user's necessities in 408.

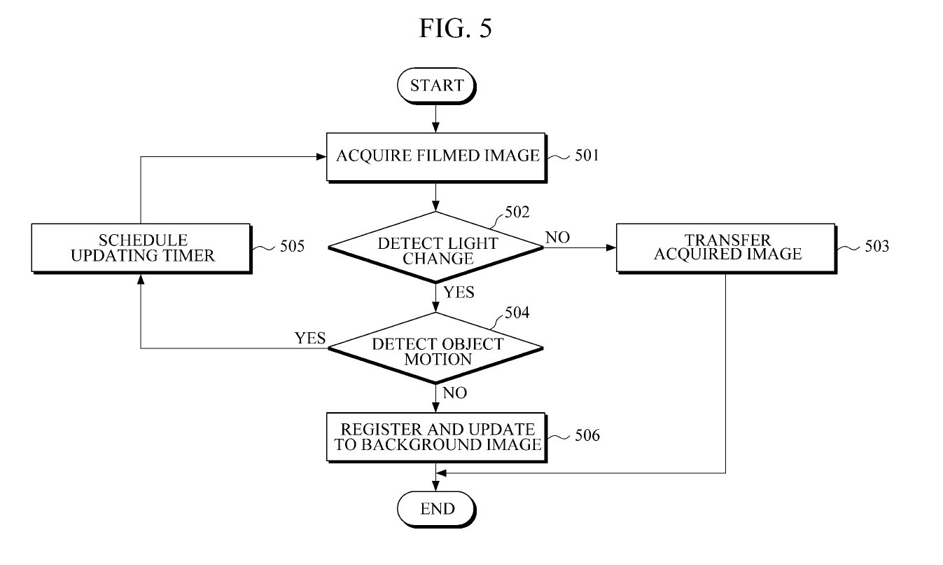

FIG. 5 is a diagram illustrating an example of a method for updating a background in a preprocessing method for recognizing a user according to an exemplary embodiment.

Referring to FIG. 5, in the background updating method of the preprocessing method for recognizing a user according to an exemplary embodiment, a filmed image is acquired in real time from an image filming device in 501. The image filming device may be configured separately with a preprocessing apparatus 100 for recognizing a user, or configured to be equipped within the preprocessing apparatus 100.

When the filmed image is received from the image filming device, a pre-registered background image is compared to the received filmed image, and a change of light environments (a difference of light) between the two images is detected in 502. The background image stored in advance is comparison standard information used in recognizing a user, and may include a code value with respect to an initial image and facial characteristics of a user's face, as well as an initial background image. According to a preset standard of a light difference after comparing the pre-registered background image and the received filmed image, if the comparison result is greater than or equal to the preset standard, it is determined that the light environments have been changed, and if the comparison result is less than or equal to the preset standard, it is determined that the light environments have not been changed. If there is a big difference of the light between the filmed image and the background image, a possibility for a distortion and an error may increase in a process of extracting a difference image. Thus, if it is determined that there has been a big difference in the light environments, the light change detector 112 needs to update the pre-registered background image to a background image that includes present light environments.

If the light change is not detected according to the preset standard of the light difference in 502, processes are performed, which are for transforming the received filmed image using a Modified Census Transform (MCT) method (same as in 404), processing into a difference image (same as in 405), removing a background noise (same as in 406), detecting a facial region candidate (same as in 407), and encoding a preprocessed image (same as in 408) in 503.

If the light change is detected according to the preset standard of the light difference in 502, two or more frames are acquired and compared at the point in time the received filmed image is detected, then the object motion is detected in 504, to update the received filmed image to a new background image. If the object motion is detected in 504, the method for updating a background waits for a predetermined amount of time in response to a preset schedule updating timer to perform a normal background image update in 505. If the schedule updating timer ends, acquiring a new filmed image is performed in 501.

If the object motion is not detected through acquiring and comparing two or more frames at the point in time when the received filmed image is detected in 504, an object motion detector 113 updates the received filmed image to a new background image, and registers the received filmed image as the new background image in 506. The newly updated background image is provided as the background for operation 404 illustrated in FIG. 4, and is transformed into an MCT background image through an MCT transform, and generates a difference image through a differentiation with an MCT filmed image. If there is a big difference in light environments, the difference image is generated after updating the pre-existing background image to a background image responding to the changed light environments through operations 501 to 504, thereby acquiring a more precise difference image responding to a large light change.

A preprocessing apparatus and preprocessing method for recognizing a user detects a user and a facial region of the user from real-time images to have strong resistance to light change during a process of preprocessing an image in a terminal. Thus, the preprocessing apparatus and method transfer meaningful data when detecting a face and identifying a user based on the preprocessed image, thereby having an advantage in reducing a transmission load. Also, the preprocessed image is transmitted except for a background region, thereby having another advantage in protecting personal information. Moreover, by enabling a registered background image, which is a subject compared with the real-time images during the process of preprocessing the image, to be adaptively updated according to a rapid light change or a background environment change when the user views TV, thereby increasing reliability for the preprocessed result.

The preprocessing methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A preprocessing apparatus of recognizing a user, comprising:
an image acquisition controller configured to compare a received filmed image and a pre-registered background image, determine whether light is changed, and update the pre-registered background image based on whether the light is changed;
a Modified Census Transform (MCT) transformer configured to transform the pre-registered background image or the updated background image through a binary conversion technique based on an average mask value that has a similar value in response to a light change, generate an MCT background image, transform the received filmed image through an MCT method, and generate an MCT filmed image; and
a difference image processor configured to differentiate the MCT filmed image and the MCT background image, and generate a difference image.

2. The preprocessing apparatus of claim 1, further comprising:
an image register configured to store the pre-registered background image, and register and store the updated background image.

3. The preprocessing apparatus of claim 1, further comprising:
a background noise remover configured to determine, as noise, a part where a size of grouped pixels included in the generated difference image is less than a predetermined standard, and remove the part; and
a facial region candidate detector configured to filter, based on facial skin color, the difference image where the noise is removed, predict a face location, reconfigure a preprocessed image, and generate the reconfigured preprocessed image.

4. The preprocessing apparatus of claim 3, wherein the reconfigured preprocessed image is configured into at least one of:
cutting an outermost region that includes all regions gone through the filtering based on the facial skin color;
in response to detection of two or more user faces, collecting only the two or more user faces and configuring the two or more user faces into one image; and
comprising the two or more user faces, each of which is considered a single image.

5. The preprocessing apparatus of claim 1, wherein the image acquisition controller comprises:
an image acquirer configured to receive the filmed image generated by an image filming device;
a light change detector configured to compare the received filmed image and the pre-registered background image, detect the light change based on a preset standard, and in response to the detection of the light change, and request an update of the pre-registered background image; and
an object motion detector configured to, in response to the request of the update of the pre-registered background image, compare two or more frames of the received filmed image, detect a motion of an object, and in response to no detection of the motion of the object, update the pre-registered background image through the filmed image.

6. The preprocessing apparatus of claim 5, wherein in response to the detection of the motion of the object, the object motion detector waits for a predetermined amount of time until the motion of the object is not detected.

7. The preprocessing apparatus of claim 1, wherein the difference image processor generates the difference image that includes only information on a user region.

8. The preprocessing apparatus of claim 1, wherein the binary conversion technique is MCT.

9. A preprocessing method for recognizing a user, comprising:
detecting whether light is changed through a comparison of a received filmed image and a pre-registered background image;
in response to no detection of whether the light is changed, transforming the pre-registered background image through a binary conversion technique based on an average mask value that has a similar value in response to a light change to generate an MCT background image, and transforming the received filmed image through an MCT method to generate an MCT filmed image; and
differentiating the MCT filmed image and the MCT background image to generate a difference image.

10. The preprocessing method of claim 9, further comprising:
determining, as not a facial region but noise, a part where a size of grouped pixels included in the generated difference image is less than a predetermined standard, and removing the part; and
filtering, based on facial skin color, the difference image where the noise is removed, predicting a face location, and reconfiguring a preprocessed image to be transmitted.

11. The preprocessing method of claim 10, wherein the reconfigured preprocessed image is configured into at least one of:
cutting an outermost region that includes all regions gone through the filtering based on the facial skin color;
in response to detection of two or more user faces, collecting only the two or more user faces and configuring the two or more user faces into one image; and
comprising the two or more user faces, each of which is considered a single image.

12. The preprocessing method of claim 9, further comprising:
in response to the detection of the light change, requesting an update of the pre-registered background image;
comparing two or more frames of the received filmed image, and detecting a motion of an object; and
in response to no detection of the motion of the object, update the pre-registered background image through the received filmed image.

13. The preprocessing method of claim 12, further comprising:
in response to the detection of the motion of the object, waiting for a predetermined amount of time until the motion of the object is not detected.

14. The preprocessing method of claim 9, wherein the difference image processor generates the difference image that includes only information on a user region.

15. The preprocessing method of claim 9, wherein the binary conversion technique is MCT.

16. A system of recognizing a user, comprising:
a preprocessing apparatus of recognizing a user, wherein the preprocessing apparatus is configured to, based on whether light is changed through a comparison of a received filmed image and a pre-registered background image, update the pre-registered background image, transform the pre-registered background image and the received filmed image through an MCT method to generate an MCT background image and an MCT filmed image, and differentiate the MCT filmed image and the MCT background image to generate a difference image to generate a preprocessed image; and
a server of recognizing a user, wherein the server is configured to analyze the generated preprocessed image, detect a facial region of a user, identify the user, and extract viewing behavior information based on the detected facial region and the identified user.

17. The system of claim 16, wherein the preprocessing apparatus determines, as not a facial region but noise, a part where a size of grouped pixels included in the generated difference image is less a predetermined standard, removes the part, filters, based on facial skin color, the difference image where the noise is removed, predicts a face location, and reconfigures a preprocessed image to be transmitted to the server.

18. The system of claim 16, wherein in response to detection of a light change, the preprocessing apparatus compares two or more frames of the received filmed image, detects a motion of an object, and in response to no detection of the motion of the object, updates the pre-registered background image through the received filmed image.
